(19) United States
(12) Patent Application Publication
(10) Pub. No.: US 2008/0262116 A1
(43) Pub. Date: Oct. 23, 2008

(54) Cross-Linked Polypropylene Resins, Method of Making Same, and Articles Formed Therefrom

(76) Inventors: Scott S. Simpson, Woodstock, CT (US); Petr Svoboda, Danielson, CT (US)

Correspondence Address: CANTOR COLBURN, LLP, 20 Church Street, 22nd Floor, Hartford, CT, 06103, US

(21) Appl. No.: 11/579,782

(22) PCT Filed: May 9, 2005
(86) PCT No.: PCT/US05/16515

§ 371 Date: Nov. 7, 2006

Related U.S. Application Data
(60) Provisional application No. 60/569,016, filed on May 7, 2004.

(51) Int. Cl. C08J 9/00

(52) U.S. Cl. 521/50.5; 521/134

(57) ABSTRACT

A foamed polymeric composition contains polypropylene and polyethylene components. The composition may have a gel content of about 10 to about 95 wt. %, per ASTM D 2765-01, method A, a density of about 16 kg/m³ to about 640 kg/m³ and a tensile elongation of at least about 200% at 150° C. per ASTM-1708-02a, speed D. Such a composition can be produced by adding an activatable foaming agent to a base resin that contains polypropylene and polyethylene components and silane functional groups, reacting the functional groups to cause cross-linking to a gel content of about 10% to about 95%, and foaming the cross-linked base resin. Alternatively, a composition may be made by adding an activatable foaming agent to the base resin, irradiating the base resin to cross-link to the stated gel content, and foaming the cross-linked base resin. Articles may be made by molding, shaping or forming such compositions.

### CROSS-REFERENCE TO RELATED APPLICATION

This application claims the benefit of U.S. provisional application No. 60/569,016, filed May 7, 2004.

### BACKGROUND

The present disclosure relates to cross-linked polyolefin compositions for the formation of foams, and methods for the production of such compositions and foams.

The preparation of foams from polyolefins typically requires cross-linking the polyolefin prior to foaming, in order to increase the melt strength of the foamed polyolefin. A material with inadequate cross-linking typically has melt strength that is too low to allow for the production of good foam. Without sufficient melt strength the polyolefin cannot be successfully processed or foamed properly, resulting in unacceptably high densities or other defects. However, excess cross-linking can make a material unsuitable for making foam because defects such as blistering are generated and because other properties, such as softness of the foam or tensile elongation, are lost. A number of methods for cross-linking have been described, for example silane grafting. In this process reactive silane groups are grafted to the polyolefin backbone, typically in an extruder in the presence of an initiator such as a peroxide. The grafted polyolefin can then be pelletized and stored, and may then be subsequently formulated and processed, for example, compounded, molded, foamed and/or cross-linked. As described by U.S. Pat. No. 4,058,583, to Glander et al., polyethylene particles may be mixed with a solution of silane with peroxide and other additives to 100° C. to obtain diffusion of these additives into the polyethylene particles, followed by grafting initiated by extrusion or radiation, which in turn is followed by exposure to and/or development of water to obtain cross-linking.

While suitable for their intended purposes, there has been a long-standing need in the art to increase the thermal resistance of foamed polyolefins. Polypropylene has been proposed for the production of such polyolefins foams because of its good thermal resistance, which is attributed to generally higher melting temperatures. Compositions based on silane-grafted polypropylene have apparently not been disclosed, however, probably because of the known instability of polypropylene to grafting conditions, in particular to peroxides. Accordingly, ungrafted polypropylene may be blended with another silane-grafted polyolefin, such as polyethylene, to produce an improved foam. In this case the polypropylene is not cross-linked, which limits its thermal resistance. For example, U.S. Pat. No. 5,929,129 to Feichtinger discloses cross-linked foamable compositions made from polyolefin copolymers. In the principal embodiments, polypropylene is blended with a silane-grafted linear polyolefin, e.g., polyethylene.

U.S. Pat. No. 4,702,868 to Pontiff et al. discloses grafting silane onto polyolefin (which may be polyethylene, a polyethylene-olefin copolymer such as polyethylene-propylene copolymer, or a blend of either of the foregoing with a polyolefin such as polypropylene), then adding foaming agent, extruding and foaming the composition, and then cross-linking the foamed material.

U.S. Pat. No. 5,567,742 to Park discloses a process in which a foaming agent is added to a lightly cross-linked polypropylene in an extruder to form a foamable gel. The polypropylene may be cross-linked chemically, using azido or vinyl functional silane. Example 7 discloses a foamed blend of which 80-90 wt. % comprised a 98%/2% polypropylene/ethylene copolymer and 10-20 wt. % of which comprised polyethylene by weight of the blend. The disclosed foams have densities of 10 to 150 kg/m³ and an average foam cell size of 0.1 to 5 mm per ASTM D3576.

U.S. Pat. No. 5,348,795 to Park discloses forming polypropylene-based foams by adding foaming agent to branched or lightly cross-linked polypropylene. The polypropylene may be cross-linked by electron beam cross-linking, as described in U.S. Pat. No. 4,916,198 to Scheve et al. or by silane cross-linking, as described in U.S. Pat. No. 4,714,716 to Park.

U.S. Pat. No. 4,714,716 discloses the preparation of foam by mixing a volatile blowing agent and a cross-linking agent into a polymer resin that contains polypropylene and extruding the mixture to simultaneously cross-link and foam the composition. Examples show the use of azido silane cross-linking agent.

Weaver et al., in “Enhancing Metallocene TPE's Performance for Extruded Applications”, Dupont Dow Elastomers, LLC, 2002, discloses the use of ethylene-α-olefin elastomers (ethylene-octene and ethylene-butene) as impact modifiers for polypropylene or polypropylene-ethylene copolymers, and modification of the elastomer by irradiation or compounding with polypropylene using low levels of peroxide/coagent to yield a product that is free from gel. Polypropylene constitutes only 20-30% of the composition. The absence of gel indicates that the compositions were not cross-linked to a significant degree, if at all

There remains a need in the art for polypropylene compositions suitable for the formation of higher thermal resistance foams. This need includes providing materials with low shrinkage, high tensile strength and/or high elongation at elevated temperatures. In particular, there remains a need for compositions that will provide foams that have high temperature resistance, but that are also thermoformable.

### SUMMARY

A foamed polymeric composition comprises a polypropylene component and a polyethylene component. The composition has a gel content of about 10 wt. % to about 95 wt. % measured in accordance with ASTM D 2765-01 (method A), a density of about 16 kg/m3 to about 640 kg/m3 (about 1 pcf to about 40 pcf) and a tensile elongation of greater than or equal to about 200% at 150° C. measured in accordance with ASTM-1708-02a at speed D.

A method for producing a polymeric composition comprises adding an activatable foaming agent to a base resin to form a foamable base resin, the base resin comprising a polypropylene component and a polyethylene component and silane functional groups, reacting the silane functional groups in the foamable base resin to cause cross-linking to a gel content of about 10% to about 95%, measured in accordance with ASTM D 2765-01, method A, and foaming the cross-linked base resin to provide a foamed polymeric composition.

In another embodiment, a method for producing a polymeric composition comprises adding an activatable foaming agent to a base resin to form a foamable base resin, the base resin comprising a polypropylene component and a polyethylene component, irradiating the foamable base resin to achieve cross-linking to a gel content of about 10% to about 95%, measured in accordance with ASTM D 2765-01, method A, and foaming the cross-linked base resin to provide a foamed polymeric composition.

An article may be made from such a composition, optionally by molding, shaping or forming the composition to form the article.

### BRIEF DESCRIPTION OF THE FIGURE

FIG. 1 is a Transmission Electron Microscope (TEM) image of a composition described herein; and

FIG. 2 is a graph of the results of a differential scanning calorimetry analysis of a foamed composition described herein.

### DETAILED DESCRIPTION

A foamed polymeric composition may be produced by adding an activatable foaming agent to a base resin to form a foamable base resin, forming the foamable base resin into a selected profile; cross-linking the foamable base resin to yield a cross-linked profile comprising the foamable, cross-linked base resin, and activating the foaming agent in the cross-linked profile to form the foamed polymeric composition. The resulting foamed compositions have sufficient temperature resistance, yet also have good thermoformability, which requires good melt strength. They also have good physical properties such as tensile strength and elongation at room temperature and at thermoforming temperatures. Such properties are generally indicated by high viscosity at temperatures above the melt temperature. A certain level of cross-linking is required in order to achieve this combination of features. In addition, the foams remain soft, as indicated by CFD tests described herein. The compositions find use as surface materials for structures in motor vehicles and elsewhere.

In some embodiments, the base resin molecules comprise cross-linking functional groups (for example, silane groups, as described further herein) that can form chemical bonds between the molecules. In such case, cross-linking the foamable base resin may comprise initiating a chemical reaction between the function groups. In other embodiments, cross-linking may be initiated by exposing the base resin to radiation, to initiate free-radical cross-linking.

The base resin comprises a polypropylene component and a polyethylene component. As used herein, the term “polypropylene component” means a polymer resin comprising polymerized propylene monomer units and, as used herein, the term “polyethylene component” means a polymer resin comprising polymerized ethylene units. The polyethylene component provides sufficient ethylene monomer units to stabilize the polypropylene against degradation in a free-radical grafting or cross-linking process. Unless otherwise specified, references herein to “monomers” or to “monomer units,” or to specific monomers (for example, “propylene”), refer to polymerized rather than free monomer molecules.

The foamed composition may comprise at least about 10%, optionally about 10 to about 97% or, in some embodiments, from about 20 to about 80% propylene by weight. In some embodiments, the foamed composition comprises less than 80 wt. % propylene, optionally about 30 to about 70 wt. % propylene. The foamed composition may comprise about 3% to about 90% ethylene, optionally about 20 to about 80% ethylene component, by weight, or in some embodiments, about 30 to about 70 wt. % ethylene component.

In some embodiments, the polypropylene component may comprise a polypropylene homopolymer such as syndiotactic polypropylene, metallocene catalyzed polypropylene, and/or isotactic polypropylene. Alternatively, or in addition, the polypropylene component may comprise a copolymer of propylene with one or more other (non-propylene) olefin monomers, wherein the copolymer comprises at least 50 mole % propylene based on the total moles of monomer units in the copolymer, optionally at least 70 mole % propylene, and in some embodiments, about 95 mole % propylene. The copolymer may comprise propylene monomer and an α-olefin comonomer of C₂ or C₄-C₂₀. For example, in some embodiments, the polypropylene component may comprise a polypropylene-ethylene copolymer, a polypropylene-butene copolymer, and/or a polypropylene-octene copolymer. Optionally, the polypropylene component may comprise a polypropylene copolymer comprising a rubber-like material such as EPR or EPDM. Thus, in some embodiments, a single copolymer resin may comprise a polypropylene component and a polyethylene component.

A polypropylene homopolymer or copolymer or combination thereof suitable for the polypropylene component may have a melt temperature of about 130° C. to about 170° C. and a melt index of about 0.5 to about 25 g/10 min (2.16 kg, 230° C.) (per ASTM D-1238-01), optionally about 1 to about 4 g/10 min (2.16 kg, 230° C.). (Unless otherwise specified, all values for melt index or melt index for base resins described herein pertain to ASTM D 1238-01 Method A, although the ASTM states that test method B can be expected to yield generally the same result.) Long branch polypropylene homopolymers useful in these compositions may have a drawdown velocity of about 200 to 300 mm/s at a force of 30 to 40 centiNewtons (cN) or, in a specific embodiment, a drawdown velocity of about 250 mm/s at a force of 38 cN.

Other polypropylene components may comprise polypropylene impact copolymers comprising a blend of polypropylene, which may be branched polypropylene, with polypropylene-polyethylene copolymer. Such materials may exhibit a melting point associated with each phase or component of the blend therein. Some suitable polypropylene impact copolymers comprise multiple materials or multiple phases, each having a DSC-discernable melting point in the copolymer, as known in the art. For example, some suitable polypropylene impact copolymers may have a first melting point (Tₘ) of about 120° C. to about 150° C., optionally about 125° C. to about 140° C., and a second melting point of about 160° C. to about 180° C., optionally about 165° C. to about 175° C., as determined by DSC, and a melt index of about 1 to about 4 g/10 min (230° C., 2.16 kg). In a particular embodiment, a suitable polypropylene impact copolymer may have a first melting point (Tₘ) of about 130° C. and a second melting point of about 170° C. Another suitable polypropylene impact copolymer has a melt index of about 2 g/10 min, a softening point of about 145° C. to about 165° C. and a deflection temperature at 0.46 megaPascals (MPa) (66 pounds per square inch (psi)) of about 85° C.

Various commercially available materials may be employed to provide a polypropylene component, such as materials from Huntsman Corporation sold under the designations P4G2Z-159, P4G2Z-073, P5M2Z-012, 18S2A, 18S4A, P6E2A-005, P6E2A-007, P6M4Z-007, and AP5325-HS; material from Atofina under the designation 1571; material from Nova Chemicals Corporation under the designation LA-0219-F; and a high melt strength polypropylene available from Borealis Corporation under the designation DAPLOY™ WB130HMS.

In some embodiments, the polyethylene component may comprise an ethylenic polyolefin separate from, but combined with, the polypropylene component. As used herein, the term “ethylenic polyolefin” means a resin that may be a polyethylene homopolymer and/or one or more copolymers of ethylene monomer units with one or more other olefin monomer units and having a polypropylene monomer content of less than 50% by weight.

Suitable polyethylene homopolymers include polyethylene resins having a melt index of about 0.5 to about 20 grams/10 minutes (20 g/10 min) (2.16 kilogram (kg), 190° C.) and a specific gravity of about 0.8 to about 1.2 grams/cubic centimeter (g/cm³). Some suitable polyethylene resins have melting temperatures of about 100° C. to about 140° C. An ethylenic polyolefin may comprise polyethylene homopolymer and/or polyethylene copolymers of ethylene monomer units with other (non-ethylene) olefin monomers, such as C₃-C₂₀ α-olefin comonomer units. The polyethylene component may optionally comprise an impact modifier for the polypropylene, such as an ethylene-propylene elastomer.

In various embodiments, the base resin may contain any number of rubber-like resins such as EPR, EPDM or other similar materials incorporated into the polypropylene component as a copolymer therewith or, alternatively, as a separate resin combined with the polypropylene component.

In particular embodiments, the ethylenic polyolefin may comprise any one or more of an ethylene-octene copolymer, an ethylene-butene copolymer, an ethylene-propylene copolymer (EPM) and/or a terpolymer of ethylene-propylene-diene (EPDM). Some suitable polyethylene copolymers include those commercially available from DuPont Dow Elastomers LLC, under the trademark ENGAGE® and from ExxonMobil, under the trademark EXACT®. For example, such materials include the ethylene-octene copolymers ENGAGE® 8200, ENGAGE™ 8130, ENR™ 8556, ENGAGE® 8411, ENGAGE® 8100, ENGAGE® 8450, ENGAGE® 8003, and the ethylene-butene copolymer ENR™ 7256, and others. Such materials may have a density of about 0.85 to about 0.9 g/cm³ and a melt index of about 0.3 to about 30 g/10 min at 2.16 kg, 190° C. Suitable ethylene-octene copolymers may contain about 15 to about 45% octene, by weight.

The ethylenic polyolefin may comprise up to about 95 wt. %, for example, about 1 wt. % to about 95 wt. %, optionally about 20 wt. % to about 80 wt. % or, more specifically, about 30 wt. % to about 70 wt. % of the combined weights of the polypropylene component and the ethylenic polyolefin in the base resin. In particular embodiments, the ethylenic polyolefin may comprise about 40 wt. % to about 60 wt. % of the base resin. Optionally, an ethylenic polyolefin may be free of polypropylene.

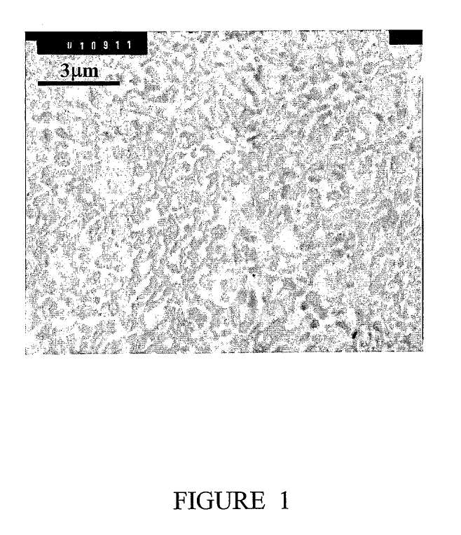

Without wishing to be bound by theory, it has been found that the degree of miscibility of the polyethylene component with the polypropylene component can be a factor in achieving a foamable material having good melt strength, with greater miscibility helping to improve the melt strength and the physical properties of the resulting foam. The formation of separated phases having dimensions of about 1 micrometer or less indicates a favorable degree of miscibility, with which good physical properties are attained. Measurement of the dimensions of the phases in the material can be made from a transmission electron micrograph (TEM), which may be produced by ultra-cryo-microtoming a sample of the material to 70 nanometer (nm) section, staining the section using RuO₄, and imaging the section using a transmission electron microscope. FIG. 1 is a TEM image of a silane-grafted base resin comprising polypropylene and an ethylene-octene copolymer, in which a high degree of miscibility is evident by virtue of the visually distinct regions having dimensions (widths, as see in the photograph) of about 0.5 μm in a co-continuous interconnected structure. It is known to those of skill in art that compositions having polypropylene/polyethylene regions of 3 μm or greater have poorer physical properties than those having regions of about 1 μm.

The base resin may be rendered cross-linkable by grafting silane functional groups onto a pre-graft resin comprising the polypropylene component and the polyethylene component. Grafted silane functional groups facilitate cross-linking in a subsequent reaction. Grafting is accomplished by combining the pre-graft resin with a silane compound and a peroxide to graft the silane compound (sometimes referred to herein as “silane,” for ease of expression) to the resin. Optionally, the grafting process may be accelerated by the use of a catalyst, as is known in the art. Suitable silanes include organo-silanes, e.g., multifunctional vinyl silanes such as vinyl trimethoxy silane (VTMOS) or vinyl triethoxy silane (VTEOS). The pre-grafted resin may be grafted with a mixture of multi-functional vinyl silanes. These silane cross-linking agents may be represented by the general formula RR′SiY₂ wherein R represents a vinyl functional radical attached to silicon through a silicon-carbon bond and composed of carbon, hydrogen, and optionally oxygen or nitrogen, wherein each Y represents a hydrolyzable organic radical, and wherein R′ represents a hydrocarbon radical or Y. For reference, U.S. Pat. No. 3,646,155 presents further examples of such silanes. In a particular embodiment, the silane may comprise vinyltrimethoxysilane.

Suitable azido-functional silanes are of the general formula RR′SiY₂, wherein R represents an azido-functional radical attached to silicon through a silicon-to-carbon bond and composed of carbon, hydrogen, optionally sulfur and oxygen, wherein each Y represents a hydrolyzable organic radical, and wherein R′ represents a monovalent hydrocarbon radical or a hydrolyzable organic radical. Suitable azido-functional silanes include the trialkoxysilanes such as 2-(trimethoxylsilyl)ethyl phenyl sulfonyl azide and (triethoxy silyl) hexyl sulfonyl azide.

The peroxide may comprise an organic peroxide, preferably an alkyl or aralkyl peroxides. Examples of such peroxides include dicumylperoxide, 2,5-dimethyl-2,5-di(t-butylperoxy)hexane, 1,1-bis(t-butylperoxy)-3,3,5-trimethylcyclohexane, 1,1-di-(t-butylperoxy)-cyclohexane, 2,2′-bis(t-butylperoxy)diisopropylbenzene, 4,4′-bis(t-butylperoxy)butylvalerate, t-butyl-perbenzoate, t-butylperterephthalate, and t-butyl peroxide. In a particular embodiment, the peroxide may comprise 2,2′-bis(t-butylperoxy)diisopropylbenzene (available under the trade name PERKADOX™).

The silane may be present in an amount of about 0.1 to about 6%, optionally about 0.25 to about 1.1% by weight of the polypropylene component and polyethylene component in the pre-graft resin. (For ease of expression, the expression “by weight of the pre-graft resin” means “by weight of the polypropylene component plus polyethylene component in the pre-graft resin”) In certain embodiments, vinyl trimethoxy silane (VTMOS) may comprise about 0.3 to about 0.4 wt. % of pre-graft resin, optionally about 0.32 to 0.36 wt. %. In one embodiment, the grafting mixture may comprise silane and peroxide in a weight ratio of about 100:1 to about 10:1, optionally, the ratio of silane to peroxide is about 50:1 to about 10:1, for example, about 20:1. In an optional embodiment, the silane/peroxide weight ratio may be about 18:1.

Grafting is induced by the addition of heat or radiation, for example by extruder compounding. Grafting (e.g., extrusion) conditions may be readily determined by one of ordinary skill in the art, and will depend on the choice of peroxide, silane, and pre-graft resin. Temperatures should be such that the decomposition of the peroxide and the subsequent grafting reaction are effective to graft the resin blend without substantial decomposition of the any of the resins. Example grafting extruder conditions are barrel temperature of about 190° C. to about 215° C., for example, 198° C. to 210° C., optionally about 200° C., extruder screw rotation of about 15 to about 35 rpm, and residence time of about 2 to about 5 minutes. Optionally, grafting is accomplished within the residence time in the extruder. Surprisingly, it has been found that tensile strength and elongation of the foamed composition at 150° C. both increase with grafting barrel temperature. A minimum barrel temperature of about 190° C. permits superior elongations to be achieved in the foamed compositions. Cross-linking may be catalyzed by exposure to a tin-containing catalyst described elsewhere herein, which can be added to the grafted resin in a subsequent process step.

In one method, grafting is accomplished by mixing the pre-graft resin comprising the polypropylene component and the polyethylene component in granulated form, with a mixture of the silane and the peroxide. Illustrative, but non-limiting, of methods of combining the various components of the base resin include melt-blending, diffusion-limited imbibition, liquid-mixing, and the like, optionally with prior pulverization or other particle-size reduction of any or all ingredients. Melt-blending may be accomplished in a batchwise or continuous process, and is preferably carried out with temperature control. Furthermore, many suitable devices for melt-blending are known to the art, including those with single and multiple Archimedean-screw conveying barrels, high-shear “Banbury” type mixers, and other internal mixers. The object of such blending or mixing, by means and conditions that are appropriate to the physical processing characteristics of the components, is to provide therein a uniform mixture. One or more components may be introduced in a step-wise fashion, either later during an existing mixing operation, during a subsequent mixing operation or, as would be the case with an extruder, at one or more downstream locations into the barrel.

When an extruder is used for grafting, the rate of addition of the silane/peroxide mixture may be about 0.1 to about 6, optionally about 0.25% to about 1.1% of the extrudate, by weight (the ‘resin feed rate’), optionally 0.3% to about 0.4%, for example, about 0.32% to about 0.36% of the combined weight of the polypropylene component and the polyethylene component in the pre-graft resin. In one embodiment, the silane/peroxide mixture may be present at about 0.4 wt. % of the resin feed rate, although others may be advantageous. The objective is to provide for a subsequently cross-linkable resin which results in a gel content of about 10% to about 95% by weight, optionally about 10% to about 80% by weight or, in some embodiments about 15% to about 50% or, in a specific embodiment, about 20% to about 40% by weight, measured in accordance with ASTM D 2765-01, method A. (Unless otherwise specified, gel content results provided here are obtained in accordance with ASTM-2765-01, method A.) In one embodiment, the gel content is about 30% by weight of the cross-linked resin. Gel content is considered to indicate the degree of cross-linking of the resin.

The feed blend to the extruder in which grafting occurs may optionally comprise antioxidants, ultra-violet absorbers, process aids and other additives. The extrudate is preferably in a form suitable for further compounding and processing, e.g., it may be pelletized and stored. Cross-linking may be induced by exposing the silane-grafted resin to moisture and/or heat and, optionally, a cross-linking catalyst, as described below.

In a particular exemplary embodiment, base resin may be extruded at a rate of approximately 10 kilogram per hour (kg/hr) using a 2-inch diameter 30:1 L/D single-screw extruder at a barrel temperature set to about 205° C. A mixture of vinyl trimethoxy silane and 2,2′-bis(t-butylperoxy)diisopropylbenzene in a weight ratio of about 18:1 may be metered directly into the feed throat of the extruder. The rate of silane/peroxide introduction is maintained at about 0.4 wt. % of resin feed rate. The grafted composition may be passed out of a multi-strand die head through a water-cooling trough, and chopped into pellets with a pelletizer.

Once formed, the base resin may be further processed as desired. For example, to produce a foamed material, a silane grafted, cross-linkable base resin may be combined with a foaming agent and a cross-linking catalyst. Optionally, a supplemental resin (a non-grafted resin) may be added after the silane grafting step. Supplemental resins, if present, comprise not more than about 40% by weight of the foamed material, optionally not more than about 20 wt. % of the foamed material.

Cross-linking compounds in addition to the above silane compounds may also be used, provided that they do not interfere with obtaining the desired product properties. One or more such additional compounds may be added to the resin with the silane compounds or in a compounding step that follows the silane grafting step. Representative additional cross-linking compounds, often referred to as “coagents,” that may be usefully employed include multifunctional vinyl monomers, organotitanates, organozirconates, and p-quinone dioximes. Illustrative, but non-limiting, examples of coagents include di- and tri-allyl cyanurates and isocyanurates, alkyl di- and tri-acrylates and methacrylates, zinc-based dimethacrylates and diacrylates, and 1,2-polybutadiene resins.

As used herein, the term “activatable foaming agents” means foaming agents that can be added to the base resin before it is cross-linked, without causing the base resin to foam, and that can be activated to cause foaming after the base resin is cross-linked. Activatable foaming agents include decomposable chemical foaming agents and certain physical blowing agents. Foaming agents useful in the practice of the current invention may be gaseous, liquid or solids. These foaming agents are usually classified as either physical blowing agents or chemical blowing agents. Physical blowing agents are compounds that are incorporated into the crosslinkable resin, that produce gas to cause expansion of the foam, by a change in physical state of the blowing agent, either from a dissolved solute state, a liquid state or a solid state to a gas state. Physical blowing agents that may be employed consist of inert gases like carbon dioxide, nitrogen or helium; halogen derivatives of methane and ethane such as methyl chloride, difluoromethane, chlorotrifluoroethane; hydrocarbon and other organic compounds such as acetylene, ammonia, hexane, propane, alcohols; and microencapsulated low boiling point hydrocarbons such as butane and pentane in a polymer shell.

Chemical blowing agents are compounds that can be incorporated into the base resin to produce gas by a chemical reaction that decomposes the foaming agent to give gas. In general, the chemical blowing agents have a decomposition temperature ranging from 130° C. to 350° C. Chemical blowing agents that can be used include azodicarbonamide, p,p′-oxybis (benzene) sulfonyl hydrazide, p-toluene sulfonyl hydrazide, p-toluene sulfonyl semicarbazide, 5-phenyltetrazole, ethyl-5-phenyltetrazole, dinitroso pentamethylenetetramine, and other azo, N-nitroso, carbonate and sulfonyl hydrazides as well as various acid-bicarbonate compounds which decompose when heated. In some embodiments, the foaming agent may comprise a solid, chemically decomposable foaming agent that can be activated after the cross-linking step, meaning that it can be caused to decompose and release gasses into the profile. Representative chemical foaming agents include azodicarbonamide, p,p′-oxybis (benzene)sulfonyl hydrazide, p-toluene sulfonyl hydrazide, p-toluene sulfonyl semicarbazide, 5-phenyltetrazole, ethyl-5-phenyltetrazole, dinitroso pentamethylenetetramine, and other azo, N-nitroso, carbonate and sulfonyl hydrazides as well as various acidibicarbonate compounds which decompose when heated.

The decomposable foaming agent may be added to the base resin before the base resin is formed into the desired profile. The foaming agent is added in an amount sufficient to attain the desired degree of foaming, for example, to attain a desired density in the foamed composition.

Many catalysts suitable for cross-linking silane-grafted polyolefin resins are known to the art. For example, one such catalyst is dibutyl tin dilaurate (DBTDL), at a level of about 0.08% of combined feed weight. Other additives may optionally be added to the base resin during this extrusion process such as cell nucleants, cell-control additives, other grafted or ungrafted resins, colorants, antioxidants, ultra-violet absorbers, stabilizers, foaming agents, flame retardants, and the like. Still other possible additives include materials such as particulate and fibrous fillers to reinforce, strengthen or modify the rheological properties of the foam composition. Also contemplated is the addition of antioxidants (e.g., hindered phenolics such as Irganox™ 1010 (tetralds-(methylene-(3,5-di-terbutyl-4-hydrocinnamate)methane), phosphites such as Irgafos™ 168, or polymerized trimethyl-dihydroquinoline such as Agerite™ AK, Resin D or Flectol™ H), ultra-violet and thermal stabilizers, pigments or colorants, cell-growth nucleants such as talc and the like, cell-structure stabilizers such as fatty-acids, -esters (e.g. glycerol monostearate) or -amides, property-modifiers, processing aids, additives, catalysts to accelerate cross-linking or other reactions, and blends of two or more of the aforementioned materials.

In other embodiments, the base resin does not include grafted functional groups for a chemical cross-linking process, but it may cross-linked by other means, such as electron beam cross-linking, as known in the art and described in U.S. Pat. No. 4,916,198, mentioned above. Combinations of methods of cross-linking may be utilized to facilitate the degree of control and achieve the desired level of cross-linking.

The foamable base resin may be extruded into a desired configuration (a “profile”) and then cross-linked to provide a foamable, cross-linked profile. The foaming agent in the foamable, cross-linked profile may then be activated. Optionally, a cross-linking catalyst in the foamable base resin may be responsive to the extrusion conditions such that the extrusion process initiates cross-linking. In some embodiments, the conditions sufficient to initiate cross-linking will not activate the foaming agent; it may be necessary to further treat the material, e.g., by heating to a higher temperature, to create the foam.

In one embodiment, the silane-grafted base resin is pelletized, the pellets are combined with a cross-linking catalyst and foaming agent and any other, optional, additives, and the resulting composition is formed into a selected profile, for example, it may be extruded as a sheet. For example, a silane-grafted base resin may be fed into an extrusion line such as a single-screw, twin screw, single screw/single screw tandem line, or single screw/accumulator tandem line with a cross-linking catalyst and an activatable foaming agent. Shaping and forming dies and mandrels may be any of those known to the art, such as sheet-producing or plank-producing dies and forming equipment. The extruder (and optional other equipment known in the art) shapes and forms the resin into the desired profile or shape. The profile is then cross-linked to provide a foamable profile comprising the foamable, cross-linked base resin, and the cross-linked profile resin is then foamed by activating the foaming agent. For example, the profile comprising the first resin may be exposed to moisture to initiate cross-linking of the silane functional groups before the foaming agent is activated. As is known in the art, activatable foaming agents that comprise decomposable chemical foaming agents may be activated by exposing the profile to elevated temperatures (e.g., by passing the sheet through an oven) to cause the foaming agent to decompose and release a substituent gas.

While being extruded or otherwise formed into a desired profile, or after such extrusion, the silane-grafted base resin may be cross-linked by exposure to heat and moisture to effect condensation reactions therein, thereby cross-linking multiples of pendant silane grafts. Cross-linking of the profile may be accomplished at ambient conditions, or by the use of warm, moist conditions. The processing temperature and permissible time of the cross-linking event are often dictated by material handling requirements, for example, by the requirement for proper conveyance of the composition through an extruder at reasonable rates. Methods of effecting the moisture induced cross-linking by condensation of silane grafts are widely disclosed in the art. Aside from exposure to hot water and/or steam, hydrated inorganic compounds such as gypsum or other water-solvable or water-absorbing species may be incorporated into the composition which, upon heating the composition above the hydration-liberation temperature, release moisture to effect the condensation of silane pendent groups.

Optionally, moisture may be introduced directly into continuous melt-processing equipment, such as an extruder, either alone or in combination with one of the components of the first resin.

For moisture-cured polyolefin systems wherein long-term moisture stability is essential, U.S. Pat. No. 4,837,272 to Kelley discloses methods of subsequently reacting the silane-grafted compositions with organo titanates to result in relatively moisture-stable adducts which readily cross-link in the presence of atmospheric moisture, even in absence of silanol condensation catalysts, to form the cross-linked structures.

In an alternative embodiment, a “Banbury” type mixer is used to blend a mixture of the silane-grafted first resin and other ungrafted resins and components. The fused mixture is then molded into a preform, cross-linked by exposure to heat, hot water and/or steam to provide a second resin, and then the foaming agent is activated. In these ways, the cross-linkable resin is processed with foaming agent therein and is formed into a selected profile that will facilitate its use in a subsequent process such as thermoforming. One example of a selected profile is a planar sheet. Other useful forms of foamed or foamable objects include expandable or foamable particles, moldable foam particles, or beads, and articles formed by expansion and/or consolidation and fusing of such particles. The selected profile is cross-linked before it is foamed. The thermoforming temperature must be at or above the melt point of at least one major polymeric component of the cross-linked base resin.

Activating a decomposable foaming agent may comprise heating the profile to a temperature sufficient to activate the decomposable foaming agent therein. In general, the decomposable foaming agent will have a decomposition temperature (with the resulting liberation of gaseous material) of about 180° C. to about 250° C. In one embodiment, the foam is activated by passing the cross-linked profile substantially vertically through an oven wherein the temperature is maintained at about 250° C. to about 320° C.

Foamed polymeric compositions as described herein have a number of advantageous properties such as low shrinkage, high tensile strength and high elongation at elevated temperatures. A cross-linked polyolefin product may take any physical configuration known in the art, such as sheet, plank, other regular or irregular extruded profiles, and regular or irregular molded bun stock, and may be processed by thermoforming without losing its strength. Uncross-linked polypropylene products lose their shape at temperatures above the melting point of the crystalline regions therein. Uncross-linked polypropylene is also known for its low viscosity upon melting, and for the tendancy to shrink excessively. For example, uncross-linked polypropylene foam having a density of 5 pounds per cubic foot (pcf) (about 0.08 grams/cubic centimeter (g/cm³)) shrinks about 66% when heated to its melting temperature, whereas some embodiments of cross-linked polypropylene foam as described herein shrink only about 23% at such temperatures.

Foamed polymeric compositions as described herein exhibit flame resistance characteristics often required for materials used in automobile passenger compartments and other environments. In particular, compositions herein provide flame resistant polyolefin foam that passes the automotive horizontal burn test to satisfy United States Department of Transportation Motor Vehicle Safety Standard 302 (“MVSS 302”). This standard is met without adding halogen or antimony compounds as flame retardants, and so may be considered environmentally friendly or “green”.

One embodiment of a method of providing a foamed polymeric composition comprises silane-grafting a pre-graft resin that comprises a polypropylene component and a polyethylene component to provide a grafted base resin, extrusion blending the base resin with a cross-linking agent and a foaming agent to provide a foamable, cross-linkable resin, extruding the foamable, cross-linkable resin into a selected profile, inducing cross-linking in the profile by exposing it to heat and moisture and, finally, activating the foaming agent. For example, the pre-graft first resin may be melt-blended with a 18:1 mixture of vinyl trimethoxy silane (VTMOS) and PERKADOX™ 14S-fl (di-(2-tert-butyl-peroxy-isopropyl)benzene) in an extruder to effect the grafting of VTMOS onto the polymers. This composition may be extruded out of a multiple-strand die face, chilled in water, and then pelletized. In a subsequent step, the silane-grafted resin, along with a decomposable foaming agent and optional additives such as ungrafted polymeric resins, colorants, pigments, dibutyl tin dilaurate silanolysis catalyst, antioxidants and/or stabilizers, are melt-blended and extruded out of a sheet die as a profile comprising a foamable, cross-linkable resin, and is then passed through a three-roll stack to shape the profile into a sheet of a selected gauge. The unexpanded sheet is then passed through a steam chamber for sufficient time to effect the cross-linking, and is then passed through a hot air/IR heat oven to effect the decomposition of the foaming agent and expansion. The cross-linked, foamed profile may then be thermoformed if desired. In various alternative embodiments, the method described herein for making a foamed composition can be practiced using a base resin that comprises any suitable polyolefin other than polypropylene and/or polyethylene.

In another embodiment, the extruded profile from the above method, before being cross-linked, may be multiple-stacked and consolidated in a press within a suitable mold at a temperature below the decomposition of the foaming agent. Subsequently, it is exposed to steam for sufficient time to effect the cross-linking via the silanolysis reaction. Optionally, at this point the resulting preform is again placed into a high-pressure press within a suitable mold to initiate the foaming agent decomposition. Finally, the partially expanded preform is fully expanded within a hot-air forced-convection oven or in a hot press.

In various embodiments, the foamed compositions described herein may have any one or more of the following properties: a density of about 1 pcf to about 40 pcf, optionally about 2 pcf to about 18 pcf or, more specifically, about 4 pcf to about 6 pcf. Some embodiments of foamed compositions described herein have a tensile elongation of at least about 300%, for example, about 300 to about 700% at 25° C. and at 150° C. (Unless otherwise specified, all tensile and elongation parameters reported herein and in the claims refer to tests pursuant to ASTM-1708-02a, speed D ((4 to 5 in.)/min) performed on samples in the machine (extrusion) direction.)

The cell size of the foamed composition may be smaller than cells in foams of the same resins produced in other ways. The average cell size of the foamed compositions described herein may be less than 1.5 mm. Optionally, the average cell size may be about 0.04 millimeters (mm)(in diameter) to about 0.33 mm, in some embodiments about 0.1 mm to about 0.2 mm. In a particular embodiment, the average cell size may be about 0.16 mm, with a standard deviation of about 0.07 mm.

In some embodiments, foamed, cross-linked resins described herein have a softer feel than comparative materials. Softness can be quantified in a Compression Force Deflection test (CFD). The measure provided by CFD is the force needed to compress a sample of the foam at a specified temperature and speed to 75% of its pre-test thickness (25% compression). In some embodiments, materials described herein have a CFD of about 6 to about 15 psi, optionally about 7 to about 12 psi at 25° C., at a compression rate of 0.2 inches/minute (0.5 cm/min). (Unless otherwise specified, all CFD measurements reported herein pertain to 25% compression at 25° C. attained at a compression speed of 0.2 inches/minute (0.5 cm/min).) In other embodiments, materials have a CFD of less than 14, optionally less than about 12 or, in some cases, less than about 10 psi.

Various embodiments of these foamed compositions may have a tensile strength at 25° C. of greater than or equal to (not less than) about 100 psi, an elongation at 25° C. of greater than or equal to about 150%, a CFD at 25° C. of at less than or equal to about 25 psi, a tensile strength at 150° C. of greater than or equal to about 5 psi, and an elongation at 150° C. of greater than or equal to about 175%. Some embodiments may have a tensile strength at 25° C. of greater than or equal to about 200 psi, an elongation at 25° C. of greater than or equal to about 250%, a CFD at 25° C. of less than or equal to about 20 psi, a tensile strength at 150° C. of greater than or equal to about 10 psi, and an elongation at 150° C. of greater than or equal to about 200%.

Optionally, embodiments of foamed compositions described herein exhibit shrinkage of less than 10%, optionally less than or equal to about 5% or, in some cases, less than or equal to about 3%. Unless otherwise specified, all shrinkage parameters set forth herein and in the claims can be obtained by placing a square sample of material on a non-stick surface (for example, a PTFE-coated plate) and placing the sample in an oven at a selected elevated temperature (for example, 170° C.) for 5 minutes and calculating the degree by which the length of the sample shrank in the machine direction.

The invention is further illustrated by the following examples, which are not limiting. Unless otherwise specified, viscosity results were obtained at 190° C. by oscillating disc rheometer at 0.1 radians per second (rad/s), over 7 minutes.

### EXAMPLE 1

Vinyltrimethoxysilane (Silquest™ A171) was grafted onto each of a series of polypropylene (PP) resins and some polyethylene resins described in Table 1A. These properties are indicative of the heat resistance of the respective resins. Resin 1E was a polypropylene impact compolymer comprising a blend of isotactic polypropylene with polypropylene-ethylene copolymer that exhibited a Tₘ for each of the two resins in the blend.

TABLE 1A

| | | | Melt Index | |
|---|---|---|---|---|
| | | Melting | g/10 min (2.16 kg, | Viscosity at 190° C. (P) |
| | Description | point(s) Tₘ by | 230° C., except where | by oscillating disc |
| Resin | (% are approximate) | DSC (° C.) | indicated) | rheometer at 0.1 rad/s |
| 1A | Isotactic | 167 | 1.9 | 137,410 |
| | homopolymer | | | |
| 1B | Isotactic | 169 | 1.9 | 168,300 |
| | homopolymer | | | |
| 1D | PP/PE random | 152 | 1.9 | 181,030 |
| | copolymer | | | |
| | comprising more than | | | |
| | 90% PP by weight | | | |
| 1E | PP/PE impact | 131/170 | 2 | 208,060 |
| | copolymer | | | |
| | comprising more than | | | |
| | 90% PP by weight | | | |
| 1F | PP/PE impact | 120/170 | 1.8 | 149,160 |
| | copolymer | | | |
| | comprising more than | | | |
| | 90% PP by weight | | | |
| 1G | syndiotactic PE | 64/130 | 2.4 | 22,921 |
| 1H | LDPE | 112 | 2.3 (at 190° C.) | 70,426 |
| 1I | Ethylene-octene | 54/77 | 2.2 (at 190° C.) | 29,224 |
| | (35 wt. % octene) | | | |
| | copolymer | | | |

The silane was grafted onto each resin of Table 1A by mixing granulated resin with VTMOS silane compound and a peroxide in an extruder. In another extruder, a cross-linking catalyst was added and cross-linking was later induced by exposing the grafted resin to moisture for 90 minutes in a steam chamber for 60 minutes at 70° C. and 90% relative humidity (RH) to induce cross-linking. The melt temperatures, melt index and viscosities of the cross-linked individual resins are set forth in Table 1B.

TABLE 1B

| | Melting | Melt index (g/10 min), | Viscosity (P) |
|---|---|---|---|
| | point Tₘ by DSC | after grafting, before | at approx. |
| | (° C.), after grafting, | cross-linking (190° C., | 190° C., |
| Resin | before cross-linking | 2.16 kg) | after cross-linking |
| 1A | 167 | 6.39 | 16,386 |
| 1B | 170 | 12.94 | 13,035 |
| 1D | 152 | 4.97 | 36,634 |
| 1B | 130/170 | 1.79 | 172,650 |
| 1F | 168 | 3.17 | 229,850 |
| 1G | 66/131 | 6.91 | 13,148 |
| 1H | 114 | 0.68 | 1,754,100 |

The data of Table 1B shows that, in most cases, the melt indices of the polypropylene resins increased somewhat, indicating a degradation of the polypropylene components. The low viscosities after the cross-linking process indicates either that, in most cases, silane cross-linking was inadequate to restore the pre-graft melt strength to polypropylene resins. Unexpectedly, resin 1F exhibited an increase in viscosity upon cross-linking after silane grafting, indicating that it would be especially useful in making a foamed product.

### EXAMPLE 2

Each of the resins of Table 1A was blended on an equal weight basis with polyethylene homopolymer (resin 1H) to form a pre-graft resin blend. Each pre-graft resin blend was grafted with the silane to provide a sample base resin, and the base resin was then cross-linked as described in Example 1. The melting point and melt index of the sample base resins, and the viscosity of the cross-linked resin blends, are set forth in Table 2.

TABLE 2

| | | | Melt index | |
|---|---|---|---|---|
| | | Melting point | (g/10 min), after | |
| | | Tₘ by DSC | grafting, before | |
| | Grafted | (° C.), after | cross-linking | Viscosity (P) |
| | Resin | grafting, before | (190° C., | at 190° C., |
| Sample | Blend | cross-linking | 2.16 kg) | after cross-linking |
| 2-1 | 1A/1H | 111/168 | 1.37 | 349,770 |
| 2-2 | 1B/1H | 111/169 | 1.40 | 309,510 |
| 2-3 | 1D/1H | 111/151 | 1.67 | 206,850 |
| 2-4 | 1E/1H | 110/169 | 0.68 | 524,060 |
| 2-5 | 1F/1H | 110/167 | 0.46 | 988,060 |
| 2-6 | 1G/1H | 110/132 | 1.41 | 377,000 |

Comparing the data of Table 2 with the data of Table 1B shows that in each case, base resins comprising grafted, uncross-linked blends of polypropylene and polyethylene components had significantly lower melt indices than the grafted resins that did not include polyethylene components. Likewise, the viscosities of the cross-linked blends reported in Table 2 were much higher than the viscosities of the cross-linked single component resins of Table 1B. This data indicates that the polyethylene component enabled cross-linking to occur and/or protected the polypropylene component against degradation during the grafting and/or the cross-linking processes. Good foams were later produced from samples 2-3 and 2-6.

In still other embodiments, materials designated 2-7 and 2-8 were prepared from a pre-graft 50/50 blend (by weight) of polypropylene resin 1E and resin 11 and an pre-graft blend of polypropylene resin 1E and polyethylene resin 1H. Sample 2-7 exhibited a viscosity of about 2,582,000 Poise (P) and material 2-8 exhibited a viscosity of about 2,287,000 P. Foam made from sample 2-7 had a surprisingly good tensile strength of about 12.9 psi at 150° C. and low dimensional shrinkage on exposure to high temperature, and a sample of this foam having a density of 7.5 pcf (120 kg/m³) a thickness of 3.29 mm exhibited flame resistance to satisfy the MVSS 302 horizontal burn test at a burning speed of 66.5 mm/minute. Thus, sample materials 2-7 and 2-8 exhibited surprisingly good heat resistance. Another low shrinkage sample foamed material (designated 2-9) was obtained from a pre-graft blend of polypropylene 1D with resin 1H.

### EXAMPLE 3

Four sample foamed polymeric materials designated M, N, O and P were prepared from blends of polypropylene (PP), polypropylene/polyethylene (PP/PE) copolymer and an ethylene-octene copolymer (PEO), as follows. A silane-grafted resin was prepared by mixing polymer resins, process aid, silane and peroxide and extrusion in single screw 2″ diameter, 30:1 (L:D) extruder at 216° C. and 15 rpm, at a throughput of about 7.5 kilogram/hour (kg/h). The extrudate was pelletized. The silane-grafted resin was extruded into a sheet profile by mixing with dibutyltin dilaurate catalyst, blowing agent and color. Extrusion in a single screw extruder with a 2½″ screw, 24:1 (L:D), at 188° C., 20 rpm, at a throughput of about 10 kg/h. The extruded sheet was 0.040 inch (about 0.1 cm) thick, 6 inches (about 15.25 cm) wide and 150 feet (about 46 meters) long. The sheet profile was cross-linked by placing it in an environmental chamber for 1 hour at 70° C. and 90% relative humidity. The cross-linked sheet was then foamed by passing the sheet through a vertical oven heated at about 300° C. with IR heaters and hot air heaters at a line speed of about 2 feet/min. The foamed sheet was cooled by passing it over 2 chill rolls, and it was then wound into a roll. Samples N and O had the same chemical formulation but were foamed under different oven conditions.

The formulations for samples M, N, O and P are set forth in the following Table 3A. The polypropylene (PP) resin 3A is a polypropylene homopolymer and has a melting point of 130° C. to 170° C., a melt index of 2.5 g/10 min (230° C./2.16 kg)(ISO 1133), a flexural modulus of 1900 MPa (ISO 178), a tensile strength at yield of 40 MPa (ISO 527-2), an elongation at yield of 6% (ISO 527-2), a tensile modulus of 1950 MPa (ISO 527-2) and heat deflection temperatures at 57.4° C. and 105° C. (ISO 75-2). The processing aid was APA™, from Ampacet, the silane was vinyl trimethoxy silane, the catalyst was 1% IRGANOX™ 1010 plus 1.6% di-butyl-tin-dilaureate in polyethlyene (PE). The foaming agent was 40% of azo dicarbonic acid diamide in PE. The white color comprised 60% white color concentrate in polyethylene.

TABLE 3A

| | Sample | | |
|---|---|---|---|
| | M | N, O | P |
| Base resin components | | | |
| Resin 3A (polypropylene) | — | 35.263 | 35.249 |
| Resin 1E (POLYPROPYLENE/PE) | 39.507 | — | — |
| Resin 1I (PEO) | 39.507 | 35.263 | 35.249 |
| Processing aid | 0.790 | 0.705 | 0.705 |
| Silane | 0.299 | 0.254 | 0.281 |
| Peroxide | 0.017 | 0.014 | 0.016 |
| Sheet extrusion | | | |
| Catalyst (DBTDL in PE) | 4.560 | 4.000 | 4.000 |
| Foaming agent (Azodicarbonimide in PE) | 12.550 | 22.000 | 22.000 |
| White color | 2.770 | 2.500 | 2.500 |
| Total | 100.000 | 100.000 | 100.000 |

The tensile and elongation of each material M, N and O was tested at various temperatures in an environmental chamber using microtensile specimens 38 mm long and 15 mm wide, pursuant to ASTM-1708-02a, speed D ((4 to 5 in.)/min). (Unless otherwise specified, all tensile and elongation tests reported herein were performed on samples in the machine (extrusion) direction). Shrinkage was tested by placing a square sample of material on a PTFE-coated plate and placing the sample in an oven at a selected elevated temperature (for example, 170° C.) for 5 minutes and calculating the degree by which the length of the sample shrank in the machine direction (unless otherwise specified, this procedure applies to all shrinkage data reported herein and in the claims). The results are set forth in the following Table 3B:

TABLE 3B

| | | | 23° C. | | 150° C. | | | |
|---|---|---|---|---|---|---|---|---|
| | density | thickness | Tensile | 23° C. | Tensile | 150° C. | 130° C. | 170° C. |
| Sample | pcf | mm | Psi | Elongation % | psi | Elongation % | Shrinkage % | Shrinkage % |
| M | 6 | 1.7 | 328 | 509 | 16.9 | 489 | | |
| N | 3.1 | 2.4 | 525 | 465 | 9.5 | 317 | 2.5 | 53.9 |
| O | 5.2 | 2.3 | | | 26.4 | 273 | | |
| P | 6.4 | 2.5 | 510 | 417 | 21.4 | 280 | 1.3 | 37 |

Metric units

| | | | 23° C. | | 150° C. | | | |
|---|---|---|---|---|---|---|---|---|
| | density | thickness | Tensile | 23° C. | Tensile | 150° C. | 130° C. | 170° C. |
| Sample | kg/m³ | mm | MPa | Elongation % | MPa | Elongation % | Shrinkage % | Shrinkage % |
| M | 96.1 | 1.7 | 2.31 | 509 | 0.12 | 489 | | |
| N | 49.7 | 2.4 | 3.6 | 465 | 0.065 | 317 | 2.5 | 53.9 |
| O | 83.3 | 2.3 | | | | 273 | | |
| P | 102.5 | 2.5 | 3.5 | 417 | 0.15 | 280 | 1.3 | 37 |

The mechanical properties of sample P were tested at 170° C. with these results: tensile strength: 5.5 psi, elongation 174%. The results show that shrinkage at 130° C. was only about 1 to 2%. This value is significantly lower than for radiation cross-linked PP/PE foams, which shrink by about 10%.

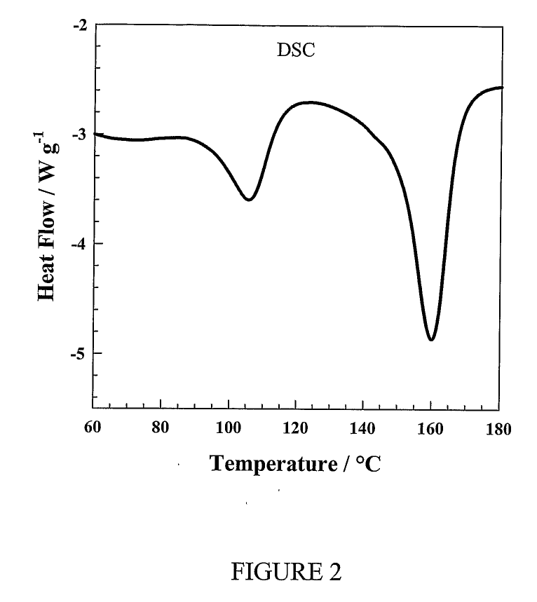

The foam made from sample O was tested by differential scanning calorimetry (DSC). The results are provided in FIG. 2. The graph in FIG. 2 shows three peaks, one at 70° C., one at 105° C. and one at 160° C. These peaks are associated with the melting points of resin 1I, polyethylene and polypropylene in the pre-graft blend. It is important that the foamed material be able to exhibit melt transitions for crystalline structures of each of the polymers in the pre-graft blend (including melt transitions of separate blocks in a block copolymer, e.g., a PP/PE block copolymer), since each resin makes a contribution to the characteristics of strength and thermoformability that provide the discovered improvement provided by these resins.

### EXAMPLE 4

Five compositions designated samples 4-1, 4-2, 4-3, 4-4 and 4-5 were prepared using various polypropylene resins. The basic formulation is set forth in Table 4A, in which B-15 is a combination of 1% Irganox™ 101 and 1.6% di-butyl-tin-dilaureate, Mw=631.0 g/mol in the form of an oily liquid comprising 18.0 wt. % Sn and having a melting point of −10° C. and a boiling point of 205° C., dispersed in low density polyethylene, and having a density (r) of 1.05 g/cm³. BAC is a decomposable chemical foaming agent comprising 60 parts by weight di azocarbamide in 40 parts polyethylene. The “pigment” is a combination of 40 parts by weight of a 50/50 combination of blue and white pigments with 60 parts polyethylene.

TABLE 4A

| Component | Weight % |
|---|---|
| Polypropylene component (various) | 35.2634 |
| Polyethylene component: Resin 1I | 35.2634 |
| APA ™ fluoropolymer process aid | 0.7053 |
| Silquest A-171 ™ VTMOS | 0.2538 |
| PERKADOX 14S-fl ™ (organic peroxide initiating | 0.0141 |
| agent) | |
| B-15 | 4.0 |
| BAC | 22.0 |
| Pigment | 2.5 |

The polypropylene component of sample 4-1 was resin 1F. The polypropylene component of sample 4-2 was resin 1G. The polypropylene component of sample 4-3 comprised a metallocene-polymerized isotactic polypropylene homopolymer and had a Tₘ of about 150° C. and a melt index of about 2.3 g/10 min (230° C.). The polypropylene component of sample 4-4 comprised a metallocene-polymerized isotactic polypropylene homopolymer and had a Tₘ of about 150° C. and a melt index of about 4 g/10 min (230° C.). The polypropylene component of sample 4-5 was resin 1D.

Foamed compositions were prepared from the indicated components in two steps. First, the polypropylene component and the ethylene-octene copolymer were combined in an extruder with the VTMOS and the PERKADOX 14S-fl to provide a polypropylene component having enough polymerized ethylene monomer groups therein to prevent substantial degradation of the polypropylene during a free-radical reaction for grafting the silane functional groups thereon. Grafting was initiated in the extruder and the grafted, cross-linkable resin was extruded and stored for further compounding. The grafted, cross-linkable resin was combined with the foaming agent and was then extruded into a selected cross-linkable profile. The profile was cross-linked by exposing the profile to 90% relative humidity at 70° C. for one hour. The cross-linked profile was then foamed by heating the profile to a temperature sufficient to activate the foaming agent (250° C.).

Samples of each foamed composition were tested for thickness, density, tensile strength at 25° C. and tensile strength and elongation at 150° C. Compression force deflection (CFD) at 25% compression was tested at 25° C. at a compression speed of 0.2 inches per minute (0.5 cm/min) (Unless otherwise specified, all results for CFD were obtained under these conditions). The test results are set forth in Table 4B.

TABLE 4B

| | Sample 4-1 | Sample 4-2 | Sample 4-3 | Sample 4-4 | Sample 4-5 |
|---|---|---|---|---|---|
| Thickness/inch | 0.086 | 0.067 | 0.085 | 0.066 | 0.069 |
| Density/pcf | 7.5 | 7.2 | 5.1 | 5.2 | 6.9 |
| Tensile at 25° C. (psi) | 329 | 240 | 317 | 327 | 325 |
| Elongation at 25° C. (%) | 507 | 521 | 493 | 468 | 520 |
| CFD | 7.81 | 8.96 | 8.08 | 6.96 | 9.48 |
| Tensile at 150° C. (psi) | 24 | 5.6 | 9.5 | 13.9 | 6.3 |
| Elongation at 150° C. (%) | 540 | 192 | 267 | 316 | 288 |

Metric units

| | | | | | |
|---|---|---|---|---|---|
| Thickness (mm) | 2.184 | 1.702 | 2.159 | 1.676 | 1.753 |
| Density (kg/m³) | 120.1 | 115.3 | 81.7 | 83.3 | 110.5 |
| Tensile at 25° C. (MPa) | 2.3 | 1.7 | 2.2 | 2.3 | 2.2 |
| Elongation at 25° C. (%) | 507 | 521 | 493 | 468 | 520 |
| CFD at 25% (MPa) | 0.054 | 0.062 | 0.056 | 0.048 | 0.065 |
| Tensile at 150° C. (MPa) | 0.17 | 0.04 | 0.07 | 0.1 | 0.04 |
| Elongation at 150° C. (%) | 540 | 192 | 267 | 316 | 288 |

The data of Table 4B shows that foam suitable for thermoforming can be made from a composition comprising polypropylene resin having a melt temperature of about 170° C. or less. Such polypropylene materials can be compounded with decomposable foaming agents and extruded under conditions that do not prematurely activate the foaming agent.

### EXAMPLE 5

Five compositions were prepared using various proportions of polypropylene or polypropylene-polyethylene copolymer and a polyethylene-octene copolymer. The formulations are set forth in Table 5A, which shows that the polypropylene component of samples 5-1 through 5-9 comprised resin 3A, whereas the polypropylene of samples 5-10 through 5-12 comprised resin 1E.

TABLE 5A

| | Sample | Sample | Sample | Sample | Sample | Sample | Sample | Sample | Sample | Sample | Sample | Sample |
|---|---|---|---|---|---|---|---|---|---|---|---|---|
| Component | 5-1 | 5-2 | 5-3 | 5-4 | 5-5 | 5-6 | 5-7 | 5-8 | 5-9 | 5-10 | 5-11 | 5-12 |
| Resin 3A | 54.5365 | 46.7640 | 46.3517 | 38.6264 | 31.1822 | 30.9012 | 23.3866 | 15.5911 | 7.7955 | — | — | — |
| (polypropylene | | | | | | | | | | | | |
| homopolymer) | | | | | | | | | | | | |
| Resin 1E PP/PE | — | — | — | — | — | — | — | — | — | 30.9012 | 38.6264 | 46.3517 |
| Resin 1I | 23.3728 | 31.1760 | 30.1286 | 37.8539 | 46.7732 | 45.5791 | 54.5688 | 62.3643 | 70.1599 | 45.5791 | 37.8539 | 30.1286 |
| PP component/ | 70/30 | 60/40 | 60/40 | 50/50 | 40/60 | 40/60 | 30/70 | 20/80 | 10/90 | 40/60 | 50/50 | 60/40 |
| PE component | | | | | | | | | | | | |
| (w/w) (approx) | | | | | | | | | | | | |
| APA | 0.7791 | 0.7794 | 0.7725 | 0.7725 | 0.7796 | 0.7725 | 0.7796 | 0.7796 | 0.7796 | 0.7725 | 0.7725 | 0.7725 |
| Silquest ™ A- | 0.2952 | 0.2658 | 0.2342 | 0.2342 | 0.2511 | 0.2342 | 0.2511 | 0.2511 | 0.2511 | 0.2342 | 0.2342 | 0.2342 |
| 171 | | | | | | | | | | | | |
| Perkadox ™ | 0.0164 | 0.0148 | 0.0130 | 0.0130 | 0.0139 | 0.0130 | 0.0139 | 0.0139 | 0.0139 | 0.0130 | 0.0130 | 0.0130 |
| 14S-fl | | | | | | | | | | | | |
| B-15 | 4.5000 | 4.5000 | 4.0000 | 4.0000 | 4.5000 | 4.0000 | 4.5000 | 4.5000 | 4.5000 | 4.0000 | 4.0000 | 4.0000 |
| BAC | 14.0000 | 14.0000 | 16.0000 | 16.0000 | 14.0000 | 16.0000 | 14.0000 | 14.0000 | 14.0000 | 16.0000 | 16.0000 | 16.0000 |
| blue/white | 2.5000 | 2.5000 | 2.5000 | 2.5000 | 2.5000 | 2.5000 | 2.5000 | 2.5000 | 2.5000 | 2.5000 | 2.5000 | 2.5000 |

Foamed compositions were formed and tested as described above in Example 4. The results are set forth in Table 5B

TABLE 5B

| | Sample | Sample | Sample | Sample | Sample | Sample | Sample | Sample | Sample | Sample | Sample | Sample |
|---|---|---|---|---|---|---|---|---|---|---|---|---|
| | 5-1 | 5-2 | 5-3 | 5-4 | 5-5 | 5-6 | 5-7 | 5-8 | 5-9 | 5-10 | 5-11 | 5-12 |
| Thickness | 0.106 | 0.074 | 0.105 | 0.117 | 0.088 | 0.132 | 0.089 | 0.086 | 0.1 | 0.13 | 0.191 | 0.209 |
| (inch) | | | | | | | | | | | | |
| Density (pcf) | 9.2 | 7.2 | 7.0 | 6.9 | 7.1 | 6.2 | 6.2 | 8.1 | 5.3 | 5.7 | 4.4 | 5.1 |
| Tensile at | 524 | 426 | 266 | 258 | 357 | 275 | 314 | 361 | 274 | 241 | 177 | 238 |
| 25° C. (psi) | | | | | | | | | | | | |
| Elongation at | 288 | 394 | 426 | 391 | 437 | 321 | 506 | 500 | 513 | 477 | 429 | 432 |
| 25° C. (%) | | | | | | | | | | | | |
| CFD at | 37.8 | 9.25 | 16.48 | 16.98 | 9.81 | 15.23 | 10.49 | 10.91 | 8.95 | 7.35 | 9.69 | 9.96 |
| 25%(psi) | | | | | | | | | | | | |
| Tensile at | 57.6 | 46.1 | 15.6 | 20.7 | 20.5 | 22.7 | 16.4 | 21.4 | 14.8 | 17.8 | 11.5 | 17.5 |
| 150° C. (psi) | | | | | | | | | | | | |
| Elongation at | 721 | 560 | 390 | 514 | 276 | 713 | 200 | 176 | 143 | 314 | 379 | 745 |
| 150° C. (%) | | | | | | | | | | | | |

Metric units

| | | | | | | | | | | | | |
|---|---|---|---|---|---|---|---|---|---|---|---|---|
| Thickness | 2.692 | 1.880 | 2.667 | 2.972 | 2.235 | 3.353 | 2.261 | 2.184 | 2.540 | 3.302 | 4.851 | 5.309 |
| (mm) | | | | | | | | | | | | |
| Density | 147.4 | 115.3 | 112.1 | 110.5 | 113.7 | 99.3 | 99.3 | 129.7 | 84.9 | 91.3 | 70.5 | 81.7 |
| (kg/m³) | | | | | | | | | | | | |
| Tensile at | 3.6 | 2.9 | 1.8 | 1.8 | 2.5 | 1.9 | 2.2 | 2.5 | 1.9 | 1.7 | 1.2 | 1.6 |
| 25° C. (MPa) | | | | | | | | | | | | |
| CFD at 25% | 0.261 | 0.064 | 0.114 | 0.117 | 0.068 | 0.105 | 0.072 | 0.075 | 0.062 | 0.051 | 0.067 | 0.069 |
| (MPa) | | | | | | | | | | | | |
| Tensile at | 0.4 | 0.3 | 0.11 | 0.14 | 0.14 | 0.16 | 0.11 | 0.15 | 0.10 | 0.12 | 0.08 | 0.12 |
| 150° C. (MPa) | | | | | | | | | | | | |

The data of Table 5B shows that when the composition comprises more than about 40 wt. % polypropylene, a precipitous improvement is seen in tensile strength and elongation, especially at 150° C. The data also shows that as the % of polypropylene in the pre-graft resin increases, elongation at 25° C. tends to decrease, but elongation at 150° C. tends to increase. At about 50 wt. % polypropylene, the elongation is about the same at either temperature, at least for the combination of resin 3A and resin 1I. For a minimum of about 200% elongation at either temperature, the pre-graft resin should comprise at least about 30 wt. % polypropylene.

### EXAMPLE 6

Fourteen sample compositions were prepared using a common polypropylene component (Resin 3A) and various polyethylene components described below (Resins 6B-6I) as set forth in Table 6-1A and Table 6-1B. The samples were made for comparison in pairs, 6-1a with 6-1b, 6-2a with 6-2b, etc., to examine the effect on differences in the level of cross-linking in the samples. Different cross-linking levels were provided by using different quantities of the VTMOS silane grafting material and peroxide (Silquest™ and Perkadox™).

Resin 6A comprised about 70 wt. % ethylene and about 30 wt. % octene comonomer and had a melt index of 1 dg/min (190° C., 2.16 kg), a Mooney viscosity of about 22 measured per ASTM D-1646 mL 1+4 at 121° C. and a DSC peak at about 78° C. (Unless otherwise specified, all Mooney viscosities reported herein refer to measurement per ASTM D-1646 mL 1+4 at 121° C.)

Resin 6B comprised about 84% ethylene and about 16 wt. % octene comonomer and had a melt index of 3.5 dg/min (190° C., 2.16 kg), a Mooney viscosity of about 10 and a DSC peak at about 98° C.

Resin 6C comprised about 62 wt. % ethylene and about 38 wt. % octene comonomer and had a melt index of 1 dg/min (190° C., 2.16 kg), a Mooney viscosity of about 23 and a DSC peak at about 60° C.

Resin 6D comprised ethylene and butene comonomer and had melt index of 2 dg/min (190° C., 2.16 kg), a Mooney viscosity of about 16 and a DSC peak at about 73° C.

Resin 6E comprised about 67 wt. % ethylene and about 33 wt. % octene comonomer and had a melt index of 18 dg/min (190° C., 2.16 kg), a Mooney viscosity of less than 5 and a DSC peak at about 72° C.

Resin 6F comprised about 62 wt. % ethylene and about 38 wt. % octene comonomer and had a melt index of about 2 dg/min (190° C., 2.16 kg), a Mooney viscosity of about 16 and a DSC peak at about 55° C.

Resin 6G comprised ethylene and about 42 wt. % octene comonomer and had a melt index of about 13 dg/min (190° C., 2.16 kg), a Mooney viscosity of less than 5 and a DSC peak at about 50° C.

Resin 6H comprised ethylene and 38 wt. % octene comonomer and had a melt index of about 5 g/10 min (190° C., 2.16 kg), a Mooney viscosity of about 8 and a DSC peak at about 60° C.

TABLE 6-1A

| | Sample | Sample | Sample | Sample | Sample | Sample | Sample | Sample |
|---|---|---|---|---|---|---|---|---|
| | 6-1a | 6-1b | 6-2a | 6-2b | 6-3a | 6-3b | 6-4a | 6-4b |
| Component | % | % | % | % | % | % | % | % |
| Resin 3A | 38.9546 | 38.9777 | 38.9546 | 38.9777 | 38.9546 | 38.9777 | 38.9546 | 38.9546 |
| (PP) | | | | | | | | |
| Resin 6A | 38.9546 | 38.9777 | 0 | 0 | 0 | 0 | 0 | 0 |
| Resin 6B | 0 | 0 | 38.9546 | 38.9777 | 0 | 0 | 0 | 0 |
| Resin 6C | 0 | 0 | 0 | 0 | 38.9546 | 38.9777 | 0 | 0 |
| Resin 6D | 0 | 0 | 0 | 0 | 0 | 0 | 38.9546 | 0 |
| Resin 6E | 0 | 0 | 0 | 0 | 0 | 0 | 0 | 38.9546 |
| APA ™ | 0.7792 | 0.7796 | 0.7792 | 0.7796 | 0.7792 | 0.7796 | 0.7792 | 0.7792 |
| Silquest ™ | 0.2952 | 0.2511 | 0.2952 | 0.2511 | 0.2952 | 0.2511 | 0.2952 | 0.2952 |
| A-171 | | | | | | | | |
| Perkadox ™ | 0.0164 | 0.0139 | 0.0164 | 0.0139 | 0.0164 | 0.0139 | 0.0164 | 0.0164 |
| 14S-fl | | | | | | | | |
| B-15 | 4.5000 | 4.5000 | 4.5000 | 4.5000 | 4.5000 | 4.5000 | 4.5000 | 4.5000 |
| BAC | 14.0000 | 14.0000 | 14.0000 | 14.0000 | 14.0000 | 14.0000 | 14.0000 | 14.0000 |
| blue/white | 2.5000 | 2.5000 | 2.5000 | 2.5000 | 2.5000 | 2.5000 | 2.5000 | 2.5000 |
| Total | 100.0000 | 100.0000 | 100.0000 | 100.0000 | 100.0000 | 100.0000 | 100.0000 | 100.0000 |

TABLE 6-1B

| | Sample 6- | Sample 6- | Sample 6- | Sample 6- | Sample 6- | Sample 6- |
|---|---|---|---|---|---|---|
| | 5a | 5b | 6a | 6b | 7a | 7b |
| Component | % | % | % | % | % | % |
| Resin 3A | 38.6264 | 38.6110 | 38.6264 | 38.6110 | 38.6264 | 38.6110 |
| Resin 6F | 37.8539 | 37.8388 | 0 | 0 | 0 | 0 |
| Resin 6G (ethylene- | 0 | 0 | 37.8539 | 37.8388 | 0 | 0 |
| octene copolymer) | | | | | | |
| Resin 6H (ethylene- | 0 | 0 | 0 | 0 | 37.8539 | 37.8388 |
| octene copolymer) | | | | | | |
| APA | 0.7725 | 0.7722 | 0.7725 | 0.7722 | 0.7725 | 0.7722 |
| Silquest ™ A-171 | 0.2342 | 0.2634 | 0.2342 | 0.2634 | 0.2342 | 0.2634 |
| Perkadox ™ 14S-fl | 0.0130 | 0.0146 | 0.0130 | 0.0146 | 0.0130 | 0.0146 |
| B-15 | 4.0000 | 4.0000 | 4.0000 | 4.0000 | 4.0000 | 4.0000 |
| BAC | 16.0000 | 16.0000 | 16.0000 | 16.0000 | 16.0000 | 16.0000 |
| blue/white | 2.5000 | 2.5000 | 2.5000 | 2.5000 | 2.5000 | 2.5000 |
| Total | 100.0000 | 100.0000 | 100.0000 | 100.0000 | 100.0000 | 100.0000 |

Samples 6-1a, 6-2a, and 6-3a were all prepared with about 0.37% Silquest™ VTMOS by weight of the combination of the polypropylene component and the polyethylene component, whereas the comparative samples 6-1b, 6-2b, and 6-3b were prepared with about 0.32% Silquest™ VTMOS by weight of the combination of the polypropylene component and the polyethylene component.

Samples 6-5a, 6-6a, and 6-7a were all prepared with about 0.3% Silquest™ VTMOS by weight of the combination of the polypropylene component and the polyethylene component, whereas the comparative samples 6-5b, 6-6b, and 6-7b were prepared with about 0.34% Silquest™ VTMOS by weight of the combination of the polypropylene component and the polyethylene component.

Foamed compositions were formed and tested as described above in Example 4. The results are set forth in Table 6-2A and 6-2B

TABLE 6-2A

| | Sample 6- | Sample 6- | Sample 6- | Sample 6- | Sample 6- | Sample 6- | Sample 6- | Sample 6- |
|---|---|---|---|---|---|---|---|---|
| | 1a | 1b | 2a | 2b | 3a | 3b | 4a | 4b |
| Thickness (inches) | 0.100 | 0.137 | 0.108 | 0.107 | 0.076 | 0.115 | 0.106 | 0.079 |
| Density (pcf) | 10.4 | 5.1 | 6.9 | 5.7 | 8.2 | 6.1 | 5.9 | 8.2 |
| Tensile at 25° C. | 512 | 225 | 299 | 414 | 474 | 273 | 255 | 375 |
| (psi) | | | | | | | | |
| Elongation at 25° C. | 439 | 366 | 409 | 447 | 453 | 443 | 388 | 446 |
| (%) | | | | | | | | |
| CFD at 25% (psi) | 25.39 | 17.17 | 19.16 | 17.42 | 15.86 | 14.35 | 13.73 | 19.48 |
| Tensile at 150° C. | 37.1 | | 21.7 | 17.8 | 20.9 | 14.1 | 19.7 | 54.7 |
| (psi) | | | | | | | | |
| Elongation at | 553 | | 463 | 515 | 297 | 534 | 400 | 301 |
| 150° C. (%) | | | | | | | | |
| Shrinkage at 170° C. | 3.8 | 0.7 | 4.7 | 2.8 | 11.2 | 6.3 | | |
| (%) | | | | | | | | |

Metric units

| | | | | | | | | |
|---|---|---|---|---|---|---|---|---|
| Thickness (mm) | 2.54 | 3.48 | 2.74 | 2.72 | 1.93 | 2.92 | 2.69 | 2.01 |
| Density (kg/m3) | 166.6 | 81.7 | 110.5 | 91.3 | 131.3 | 97.7 | 94.5 | 131.3 |
| Tensile at 25° C. | 3.53 | 1.55 | 2.06 | 2.85 | 3.27 | 1.88 | 1.76 | 2.59 |
| (MPa) | | | | | | | | |
| Elongation at 25° C. | 439 | 366 | 409 | 447 | 453 | 443 | 388 | 446 |
| (%) | | | | | | | | |
| CFD at 25% (MPa) | 0.175 | 0.118 | 0.132 | 0.120 | 0.109 | 0.099 | 0.095 | 0.134 |
| Tensile at 150° C. | 0.26 | | 0.15 | 0.12 | 0.14 | 0.1 | 0.14 | 0.38 |
| (MPa) | | | | | | | | |
| Elongation at | 553 | | 463 | 515 | 297 | 534 | 400 | 301 |
| 150° C. (%) | | | | | | | | |
| Shrinkage at 170° C. | 3.8 | 0.7 | 4.7 | 2.8 | 11.2 | 6.3 | | |
| (%) | | | | | | | | |

TABLE 6-2B

| | Sample 6- | Sample 6- | Sample 6- | Sample 6- | Sample 6- | Sample 6- |
|---|---|---|---|---|---|---|
| | 5a | 5b | 6a | 6b | 7a | 7b |
| Thickness (inch) | 0.128 | 0.131 | 0.112 | 0.111 | 0.123 | 0.122 |
| Density (pcf) | 5 | 4.2 | 5.8 | 5.9 | 6.5 | 6.9 |
| Tensile at 25° C. (psi) | 160 | 160 | 103 | 161 | 184 | 211 |
| Elongation at 25° C. (%) | 267 | 304 | 151 | 266 | 245 | 258 |
| CFD at 25° C. (psi) | 17.21 | 10.62 | 12.89 | 21.72 | 23.71 | 24.5 |
| Tensile at 150° C. (psi) | 5.7 | 10.6 | 8.4 | 13.1 | 5.3 | 10.1 |
| Elongation at 150° C. (%) | 336 | 257 | 256 | 252 | 346 | 436 |

Metric units

| | | | | | | |
|---|---|---|---|---|---|---|
| Thickness (mm) | 3.25 | 3.324 | 2.85 | 2.82 | 3.12 | 3.1 |
| Density (kg/m³) | 80.1 | 67.3 | 92.9 | 94.5 | 104.1 | 110.5 |
| Tensile at 25° C. (MPa) | 1.1 | 1.1 | 0.7 | 1.1 | 1.3 | 1.5 |
| Elongation at 25° C. (%) | 267 | 304 | 151 | 266 | 245 | 258 |
| CFD at 25% (MPa) | 0.119 | 0.073 | 0.089 | 0.150 | 0.163 | 0.169 |
| Tensile at 150° C. (MPa) | 0.04 | 0.07 | 0.06 | 0.09 | 0.04 | 0.07 |
| Elongation at 150° C. (%) | 336 | 257 | 256 | 252 | 346 | 436 |

The data of Table 6-2A and 6-2B shows that a small in increase in the amount of silane yielded surprising improvements in the tensile strength at 150° C. of the cross-linked compositions, in some cases without a significant loss of elongation. Surprising improvement is also seen in shrinkage at 170° C. The data also shows that a wide variety of polyethylene-octene copolymers can be used in compositions that exhibit good tensile strength and elongation.

### EXAMPLE 7

Three compositions were prepared using sample compositions were prepared using a common polypropylene component (Resin 3A) (Daploy™ HMS) and various polyethylene components (Resins 7A-7C). The formulations of these compositions are set forth in Table 7A:

TABLE 7A

| | Sample 7-1 | Sample 7-2 | Sample 7-3 |
|---|---|---|---|
| Component | % | % | % |
| Resin 3A Polypropylene | 38.6264 | 38.6264 | 38.6264 |
| Resin 7A | 37.8539 | 0 | 0 |
| Ethylene-octene copolymer | | | |
| Resin 7B | 0 | 37.8539 | 0 |
| Ethylene-octene copolymer | | | |
| Resin 7C | 0 | 0 | 37.8539 |
| Ethylene-butene copolymer | | | |
| APA ™ | 0.7725 | 0.7725 | 0.7725 |
| Silquest ™ A-171 | 0.2342 | 0.2342 | 0.2342 |
| Perkadox ™ 14S-fl | 0.0130 | 0.0130 | 0.0130 |
| B-15 | 4.0000 | 4.0000 | 4.0000 |
| BAC | 16.0000 | 16.0000 | 16.0000 |
| blue/white | 2.5000 | 2.5000 | 2.5000 |
| Total | 100.0000 | 100.0000 | 100.0000 |

Resin 7A (Ethylene-octene copolymer) comprised ethylene and about 42 wt. % octene comonomer and had a melt index of 0.5 dg/min (190° C., 2.16 kg), a Mooney viscosity of about 35 and a DSC peak at about 49° C.

Resin 7B (ethylene-octene copolymer) comprised ethylene and about 39 wt. % octene comonomer and had a melt index of 0.5 dg/min (190° C., 2.16 kg), a Mooney viscosity of about 35 and a DSC peak at about 55° C.

Resin 7C (ethylene-butene copolymer) comprised about 40 wt. % butene comonomer and had a Mooney viscosity of about 20, a melt index of 1.2 (190° C., 2.16 kg) and a DSC peak at about 36° C.

Foamed compositions were formed and tested as described above in Example 4. The results are set forth in Table 7B.

TABLE 7B

| | Sample 7-1 | Sample 7-2 | Sample 7-3 |
|---|---|---|---|
| Thickness/inch | 0.134 | 0.119 | 0.148 |
| Density/pcf | 5.2 | 5.4 | 5.5 |
| Tensile at 25° C./psi | 198 | 152 | 152 |
| Elongation at 25° C./% | 390 | 345 | 353 |
| CFD at 25%/psi | 13.06 | 15.1 | 9.76 |
| Tensile at 150° C./psi | 9.8 | 7.5 | 13 |

Metric units

| | | | |
|---|---|---|---|
| Elongation at 150° C./% | 312 | 303 | 388 |
| Thickness (mm) | 3.404 | 3.023 | 3.759 |
| Density (kg/m³) | 83.3 | 86.5 | 88.1 |
| Tensile at 25° C. (MPa) | 1.4 | 1 | 1 |
| Elongation at 25° C. (%) | 390 | 345 | 353 |
| CFD at 25% (MPa) | 0.090 | 0.104 | 0.067 |
| Tensile at 150° C. (MPa) | 0.07 | 0.05 | 0.09 |
| Elongation at 150° C. (%) | 312 | 303 | 388 |

Although other samples prepared from ethylene-butene resin did not yield acceptable foam, the data of Table 7B shows that ethylene-butene copolymers can be used as described herein to produce foamed compositions having good physical properties.

### EXAMPLE 8

### Comparative Examples

A series of commercially available materials considered to be comparable to the compositions described herein were obtained and tested. Analysis of the materials indicates that samples C-1 and C-3 comprised blends of polypropylene and polyethylene, while sample C-2 comprised only polypropylene. The results are set forth in the following Table 8.

TABLE 8

| | | | Tensile | | CFD | Tensile | | |
|---|---|---|---|---|---|---|---|---|
| | Thickness | Density | at 25° C. | Elongation | at 25° C. | at 150° C. | Elongation | |
| Sample | inch | pcf | psi | at 25° C. % | psi | psi | at 150° C. % | Polymer |
| C-1 | 0.0793 | 3.7 | 254 | 123 | 22.24 | 17.7 | 176 | PP/PE |
| C-2 | 0.1177 | 4.9 | 247 | 27 | 14.43 | 39.8 | 667 | PP |
| C-3 | 0.1026 | 4.6 | 247 | 304 | 26.94 | 22.5 | 221 | PP/PE |

Metric units

| | | | Tensile | | CFD | Tensile | | |
|---|---|---|---|---|---|---|---|---|
| | Thickness | Density | at 25° C. | Elongation | at 25° C. | at 150° C. | Elongation | |
| Sample | mm | kg/m³ | MPa | at 25° C. % | MPa | MPa | at 150° C. % | Polymer |
| C-1 | 2.01 | 59.3 | 1.8 | 123 | 0.153 | 0.12 | 176 | PP/PE |
| C-2 | 2.93 | 78.5 | 1.7 | 27 | 0.099 | 0.27 | 667 | PP |
| C-3 | 2.61 | 73.7 | 1.7 | 304 | 0.186 | 0.16 | 221 | PP/PE |

The data of Table 8 shows that competitive materials do not attain the same characteristics as the compositions described herein. In particular, comparative materials C-1 and C-2 had inadequate elongation at 25° C., and all of the materials had high CFD values, indicating that the foam was stiffer than desired and stiffer than materials disclosed herein. C-2 also had very large cells, averaging 2 mm.

### EXAMPLE 9

An uncross-linked resin for sample 9-1 was prepared by combining the components set forth in Table 9A, which are similar to those of sample 5-4, as shown in Table 9A for comparison. The resin was extruded through a sheet die and treated with an electron beam to effect cross-linking, using various levels of radiation exposure. The cross-linked sheets were then foamed by passing the sheet through an oven at 270° C. to initiate the foaming agent. The resulting foamed compositions were tested, and the radiation doses of the best samples (reported in kiloGrays (kGy)) are set forth in Table 9B together with the physical properties of the resulting foam materials and corresponding physical properties of sample 5-4.

TABLE 9A

| | Sample 9-1 | Sample 5-4 |
|---|---|---|
| Component | Wt. % | Wt. % |
| Resin 3A (PP homopolymer) | 38.75 | 38.6264 |
| Resin 1I (ethylene-octene | 37.98 | 37.8539 |
| copolymer) | | |
| APA | 0.78 | 0.7725 |
| B-15 | 4.00 | 4.00 |
| BAC | 16.00 | 16 |
| blue/white | 2.50 | 2.5 |
| Total | 100.00 | 100.7528 |

TABLE 9B

| | | | Tensile | Elongation | CFD | Tensile | Elongation |
|---|---|---|---|---|---|---|---|
| | thickness | density | 25° C. | 25° C. | 25° C. | 150° C. | 150° C. |
| Radiation level | inch | Pcf | psi | % | psi | psi | % |
| 80 kGy | 0.144 | 5.1 | 120 | 196 | | 4.47 | 305 |
| 90 kGy | 0.133 | 5.4 | 130 | 192 | 17.00 | 5.12 | 354 |
| 100 kGy | 0.144 | 5.0 | 125 | 202 | 14.96 | 6.38 | 331 |
| 110 kGy | 0.137 | 4.9 | 141 | 203 | 17.57 | 7.26 | 314 |
| 120 kGy | 0.145 | 4.9 | 191 | 230 | | 9.48 | 299 |
| sample 5-4 | 0.117 | 6.9 | 258 | 391 | 16.98 | 20.7 | 514 |
| (silane x-1) | | | | | | | |

Metric units

| | | | Tensile | Elongation | CFD | Tensile | Elongation |
|---|---|---|---|---|---|---|---|
| | thickness | density | 25° C. | 25° C. | 25° C. | 150° C. | 150° C. |
| Radiation level | mm | kg/m³ | MPa | % | MPa | Mpa | % |
| 80 kGy | 3.658 | 81.7 | 0.8 | 196 | | 0.031 | 305 |
| 90 kGy | 3.378 | 86.5 | 0.9 | 192 | 0.117 | 0.035 | 354 |
| 100 kGy | 3.658 | 80.1 | 0.9 | 202 | 0.103 | 0.044 | 331 |
| 110 kGy | 3.480 | 78.5 | 1 | 203 | 0.121 | 0.050 | 314 |
| 120 kGy | 3.683 | 78.5 | 1.3 | 230 | | 0.065 | 299 |
| sample 5-4 | 2.972 | 110.5 | 1.8 | 391 | 0.117 | 0.14 | 514 |
| (silane x-1) | | | | | | | |

Table 9B only shows data for samples irradiated at 80 kGy to 120 kGy, since these radiation levels produced acceptable foam. Samples irradiated with less than 80kGy were too soft to provide a useful foamed product, and samples irradiated with more than 120 kGy appeared to be excessively cross-linked because, upon foaming, they formed blisters and other unacceptable defects. An 80 kGy sample has a gel content of about 31%, whereas a 120 kGy sample had a gel content of about 68%. The data of Table 9B shows, surprisingly, that a sample prepared by the silane-grafted resin as described herein yields materials with generally better physical properties than a comparable material produced using electron beam cross-linking. In particular, sample 5-4 had significantly better elongation and tensile strength both at 25 and 150° C. than the best of the electron beam cross-linked samples.

### EXAMPLE 10

Three sample foamed compositions designated 10A, 10B and 10C, all containing high proportions of polypropylene in a blend with polyethylene-octene resin 1I, were prepared in generally the same manner as described in Example 3.

Sample 10A contained 70 wt. % polypropylene resin 3A, whereas Sample 10B comprised 80 wt. % polypropylene resin 3A. Samples 10A and 10B were grafted with the same proportion of VTMOS silane in the pre-graft resin (0.32 wt. % by the weight of resins 3A and 1I).

Sample 10C contained 80 wt. % polypropylene resin 3A but was grafted with 0.36% VTMOS silane by weight of resins 3A and 1I.

The foamed samples were tested and the results are set forth in Table 1A.

TABLE 10A

| | Foam | Foam | | Elongation | | | Elongation |
|---|---|---|---|---|---|---|---|
| | thickness | density | Tensile | 25° C. | CFD | Tensile | 150° C. |
| Sample | Inch | Pcf | Psi, 25° C. | % | Psi, 25° C. | Psi, 150° C. | % |
| 10A | 0.141 | 4.5 | 162 | 90 | 22.75 | 12. | 739 |
| PS-342 | | | | | | | |
| 10B | 0.156 | 5 | 148 | 20 | 23.68 | 11.7 | 753 |
| PS-345 | | | | | | | |
| 10C | 0.146 | 5 | 114 | 26 | 17.04 | 5.9 | 183 |
| PS-346 | | | | | | | |

Metric units

| | | | 25° C. | 25° C. | | 150° C. | 150° C. |
|---|---|---|---|---|---|---|---|
| | thickness | density | tensile | elongation | CFD | tensile | elongation |
| | mm | kg/m3 | MPa | % | MPa | Mpa | % |
| 10A, PS-342 | 3.581 | 72 | 1.1 | 90 | 0.157 | 0.08 | 739 |
| 10B, PS-345 | 3.962 | 80 | 1.0 | 20 | 0.163 | 0.08 | 753 |
| 10C, PS-346 | 3.708 | 80 | 0.8 | 26 | 0.117 | 0.04 | 183 |

The data of Table 10A shows that a useful foam can be made from a pre-graft resin comprising up to 80 wt. % polypropylene.

### EXAMPLE 11

Four compositions were prepared using various polypropylene resins. The basic formulation is set forth in Table 11A:

TABLE 11A

| Component | Weight % |
|---|---|
| Selected polypropylene component | 38.6264 |
| Resin 1I | 37.8539 |
| APA ™ fluoropolymer process aid | 0.7725 |
| Silquest A-171 ™ VTMOS | 0.2342 |
| PERKADOX 14S-fl ™ (organic peroxide initiating | 0.013 |
| agent) | |
| B-15 | 4.0 |
| BAC | 16.0 |
| Blue/white Pigment | 2.5 |
| Total | 100 |

The polypropylene component of sample 11-1 comprised resin polypropylene impact copolymer resin 1E.

The polypropylene component of sample 11-2 comprised a poly(propylene-ethylene) impact copolymer and had a melting point (Tm) of about 129° C. and 165° C. and a melt index of about 4 g/10 min (230° C., 2.16 kg).

The polypropylene component of sample 11-3 comprised a poly(propylene-ethylene) impact copolymer and had a melting point (Tm) of about 116° C. and 165° C. and a melt index of about 8 g/10 min (230° C., 2.16 kg).

The polypropylene component of sample 11-4 comprised a poly(propylene-ethylene) impact copolymer and had a melting point (Tm) of about 125° C. and 165° C. and a melt index of about 20 g/10 min (230° C., 2.16 kg).

Foamed compositions were prepared from the indicated components in generally the same manner as described in Example 3. Samples of each foamed composition were tested for thickness, density, tensile strength and elongation at 25° C. and 150° C. and for compression force deflection (CFD). Tensile and elongation at 150° C. for sample formulation 11-3 were tested on a sample grafted with 0.32 wt. % silane in the pre-graft resin (exclusive of the B-15, BAC or pigment). The test results are set forth in Table 11B.

TABLE 11B

| | 11-1 | 11-12 | 11-3 | 11-4 |
|---|---|---|---|---|
| Thickness/inch | 0.191 | 0.092 | 0.118 | 0.102 |
| Density/pcf | 4.4 | 4.3 | 5.6 | 4.6 |
| Tensile at 25° C. (psi) | 177 | 170 | 155 | 180 |
| Elongation at 25° C. (%) | 429 | 441 | 406 | 423 |
| CFD at 25% (psi) | 9.69 | 8.45 | 14.41 | 7.22 |
| Tensile at 150° C. (psi) | 11.5 | 7.1 | 6.2 | 8. |
| Elongation at 150° C. (%) | 379 | 698 | 330 | 355 |
| Metric units | | | | |
| Thickness (mm) | 4.851 | 2.337 | 2.997 | 2.591 |
| Density (kg/m³) | 70.5 | 68.9 | 89.7 | 73.7 |
| Tensile at 25° C. (MPa) | 1.2 | 1.2 | 1. | 1.2 |
| Elongation at 25° C. (%) | 429 | 441 | 406 | 423 |
| CFD at 25% (MPa) | 0.067 | 0.058 | 0.099 | 0.050 |
| Tensile at 150° C. (MPa) | 0.08 | 0.05 | 0.04 | 0.06 |
| Elongation at 150° C. (%) | 379 | 698 | 330 | 355 |

The data of Table 11B shows that useful foam can be produced from a polypropylene component having a melt index of about 2 to about 20 g/10 min (190° C., 2.16 kg).

The terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item. Unless defined otherwise, technical and scientific terms used herein have the same meaning as is commonly understood by one of skill in the art to which this invention belongs. All ranges disclosed herein are inclusive and combinable (e.g., ranges of “up to about 25 wt. %, with about 5 wt. % to about 20 wt. % desired,” is inclusive of the endpoints and all intermediate values of the ranges of “about 5 wt. % to about 25 wt. %,” etc.). The modifier “about” used in connection with a quantity is inclusive of the stated value and has the meaning dictated by the context (e.g., includes the degree of error associated with measurement of the particular quantity).

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the foregoing description and/or the appended claims.

What is claimed is:

1. A composition comprising:
a foamed polymeric composition comprising a polypropylene component and a polyethylene component; wherein the composition has
a gel content of about 10 wt. % to about 95 wt. % measured in accordance with ASTM D 2765-01, method A;
a density of about 16 kg/m³ to about 640 kg/m³ (about 1 pcf to about 40 pcf); and
a tensile elongation of greater than or equal to about 200% at 150° C. measured in accordance with ASTM-1708-02a at speed D.

2. The composition of claim 1, wherein the composition has a tensile elongation of greater than or equal to about 200% at 150° C. and at 25° C., measured in accordance with ASTM-D1708-02a (test speed D).

3. The composition of claim 1, wherein the composition has a tensile elongation of greater than or equal to about 300% at 150° C. and at 25° C., measured in accordance with ASTM-D1708-02a (test speed D).

4. The composition of claim 1, wherein the composition has a tensile elongation of about 200% to about 700% at 150° C., measured in accordance with ASTM-D1708-02a (test speed D).

5. The composition of claim 1, wherein a sample sized for testing in accordance with ASTM-D1708-02a has a compression force deflection (CFD) for 25% compression of less than or equal to about 0.103 Mpa (15 psi) at 25° C., measured at 0.5 cm (0.2 inches)/minute compression speed.

6. The composition of claim 1 comprising foam cells having an average diameter of about 0.04 millimeter (mm) to about 0.33 mm.

7. The composition of claim 1, wherein the polypropylene component has a melt index of about 2 to about 20 g/10 min (190° C., 2 kg) per ASTM D-1238.

8. The composition of claim 1, about 30% to about 70% propylene, by weight.

9. The composition of claim 1, comprising a polypropylene-ethylene copolymer, and wherein the polyethylene component comprises a polyethylene-octene copolymer or a polyethylene-butene copolymer or a combination of ethylenic polyolefins comprising at least one of aforesaid polyethylene copolymers.

10. The composition of claim 1, comprising a polypropylene impact copolymer having a first melting point (Tₘ) of about 120° C. to about 150° C. and a second melting point of about 160° C. to about 180° C. as determined by DSC and a melt index of about 1 to about 4 g/10 min (230° C., 2.16 kg); and
wherein the polyethylene component comprises an ethylene-octene copolymer comprising about 15 to about 45% octene by weight of the ethylene-octene copolymer and having a melt index of about 0.5 to about 18 dg/min (190° C., 2.16 kg) per ASTM D-1238.

11. The composition of claim 1, comprising a polypropylene impact copolymer having a first melting point (Tₘ) of about 130° C. and a second melting point of about 170° C. as determined by DSC and a melt index of about 1 to about 4 g/10 min (230° C., 2.16 kg); and
wherein the polyethylene component comprises an ethylene-octene copolymer comprising about 15 to about 45% octene by weight of the ethylene-octene copolymer and having a melt index of about 0.5 to about 18 dg/min (190° C., 2.16 kg) per ASTM D-1238.

12. The composition of claim, 1, comprising a polypropylene homopolymer having a melting point of about 130° C. to about 150° C. and a melt index of about 1 to about 4 g/10 min (230° C./2.16 kg)(ISO 1133); and
wherein the polyethylene component comprises an ethylene-octene copolymer comprising about 15 to about 45% octene by weight of the ethylene-octene copolymer and having a melt index of about 1 to about 4 dg/min (190° C., 2.16 kg) per ASTM D-1238.

13. The composition of claim 1, wherein the polypropylene component comprises a polypropylene homopolymer having a melting point of about 165° C. and a melt index of about 2.5 g/10 min (230° C./2.16 kg)(ISO 1133); and
wherein the polyethylene component comprises an ethylene-octene copolymer comprising about 15 to about 45% octene by weight of the ethylene-octene copolymer and having a melt index of about 1 to about 4 dg/min (190° C., 2.16 kg) per ASTM D-1238.

14. The composition of claim 1, having a tensile strength at 25° C. of greater than or equal to about 100 psi, an elongation at 25° C. of greater than or equal to about 150% measured in accordance with ASTM-D1708-02a (test speed D), a CFD at 25° C. of at less than or equal to about 25 psi, a tensile strength at 150° C. of greater than or equal to about 5 psi, and an elongation at 150° C. of greater than or equal to about 175% measured in accordance with ASTM-D1708-02a (test speed D).

15. The composition of claim 14, having a shrinkage of less than 10%.

16. The composition of claim 1, having a tensile strength at 25° C. of greater than or equal to about 200 psi, an elongation at 25° C. of greater than or equal to about 250% measured in accordance with ASTM-D1708-02a (test speed D), a CFD at 25° C. of less than or equal to about 20 psi, a tensile strength at 150° C. of greater than or equal to about 10 psi, and an elongation at 150° C. of greater than or equal to about 200% measured in accordance with ASTM-D1708-02a (test speed D).

17. The composition of claim 16, having a shrinkage of less than 10%.

18. The composition of claim 1, wherein the polyethylene component comprises a polyethylene-butene copolymer.

19. The composition of claim 1, wherein the polyethylene component comprises a polyethylene-butene copolymer that contains about 40% butene by weight of the copolymer.

20. A method for producing a polymeric composition, the method comprising:
adding an activatable foaming agent to a base resin to form a foamable base resin, the base resin comprising a polypropylene component and a polyethylene component and silane functional groups;
reacting the silane functional groups in the foamable base resin to cause cross-linking to a gel content of about 10% to about 95%, measured in accordance with ASTM D 2765-01, method A; and
foaming the cross-linked base resin to provide a foamed polymeric composition.

21. The method of claim 20, wherein the foamed polymeric composition has a density of about 16 kg/m³ to about 640 kg/m³ (about 1 pcf to about 40 pcf); and
a tensile elongation of greater than or equal to about 200% measured in accordance with ASTM-1708-02a at speed D, at 150° C.

22. The method of claim 20, wherein the base resin comprises a polypropylene impact copolymer having a first melting point (Tₘ) of about 120° C. to about 150° C. and a second melting point of about 160° C. to about 180° C. as determined by DSC and a melt index of about 1 to about 4 g/10 min (230° C., 2.16 kg), and
wherein the polyethylene component comprises an ethylene-octene copolymer comprising about 15 to about 45% octene by weight of the ethylene-octene copolymer and having a melt index of about 0.5 to about 18 dg/min (190° C., 2.16 kg) per ASTM D-1238.

23. The method of claim 20, wherein the base resin comprises a polypropylene impact copolymer having a first melting point (Tₘ) of about 130° C. and a second melting point of about 170° C. as determined by DSC and a melt index of about 1 to about 4 g/10 min (230° C., 2.16 kg); and
wherein the polyethylene component comprises an ethylene-octene copolymer comprising about 15 to about 45% octene by weight of the ethylene-octene copolymer and having a melt index of about 0.5 to about 18 dg/min (190° C., 2.16 kg) per ASTM D-1238.

24. The method of claim 20, wherein the base resin comprises a polypropylene homopolymer having a melting point of about 130° C. to about 150° C. and a melt index of about 1 to about 4 g/10 min (230° C./2.16 kg)(ISO 1133); and
wherein the polyethylene component comprises an ethylene-octene copolymer comprising about 15 to about 45% octene by weight of the ethylene-octene copolymer and having a melt index of about 1 to about 4 dg/min (190° C., 2.16 kg) per ASTM D-1238.

25. The method of claim 20, wherein the base resin comprises a polypropylene homopolymer having melting point of about 165° C. and a melt index of about 1 to about 4 g/10 min (230° C./2.16 kg)(ISO 1133) and the polyethylene component comprises an ethylene-octene copolymer comprising about 15 to about 45% octene by weight of the ethylene-octene copolymer and having a melt index of about 1 to about 4 dg/min (190° C., 2.16 kg) per ASTM D-1238.

26. The method of claim 20, wherein the foamed composition comprises at least about 40% propylene units by weight.

27. The method of claim 20 wherein the polypropylene component has a melt index of about 2 to about 20 g/10 min (190° C., 2 kg) per ASTM D-1238.

28. A method for producing a polymeric composition, the method comprising:
adding an activatable foaming agent to a base resin to form a foamable base resin, the base resin comprising a polypropylene component and a polyethylene component;
irradiating the foamable base resin to achieve cross-linking to a gel content of about 10% to about 95%, measured in accordance with ASTM D 2765-01, method A; and
foaming the cross-linked base resin to provide a foamed polymeric composition.

29. The method of claim 28, wherein cross-linking the base resin comprises irradiating the base resin with about 80 kGy to about 120 kGy radiation.

30. A polymeric composition resulting from the process of method claim 20.

31. A polymeric composition resulting from the process of method claim 28

32. An article formed from the composition of composition claim 1.

33. A method for forming an article, comprising molding, shaping, extruding or forming the composition of claim 1 to form the article.
